(19) United States
(12) Patent Application Publication
(10) Pub. No.: US 2006/0031924 A1
(43) Pub. Date: Feb. 9, 2006

(54) Message processing apparatus and method in a portable internet system

(75) Inventors: Jae-Woo Kwon, Suwon-si (KR); Hong-Sung Chang, Suwon-si (KR); Nae-Hyun Lim, Yongin-si (KR); Jun-Hyuk Song, Anyang-si (KR); Jung-Shin Park, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/196,731

(22) Filed: Aug. 4, 2005

(30) Foreign Application Priority Data
Aug. 4, 2004 (KR) 2004-61529

(51) Int. Cl. H04L 9/32; G06K 9/00; G06F 17/30; G06F 7/04

(52) U.S. Cl. 726/2

(57) ABSTRACT

The invention relates to a message processing method and apparatus in a portable Internet system, in which a base station of the portable Internet system is designed to have a number of connection processors and connection controllers. This can increase the number of mobile subscriber stations that a single base station can provide a service and efficiently manage information necessary for providing a service to the mobile subscriber stations.

### CLAIM OF PRIORITY

This application claims the benefit under 35 U.S.C. §119(a) from an application for “MESSAGE PROCESSING APPARATUS AND METHOD IN A PORTABLE INTERNET SYSTEM” filed in the Korean Intellectual Property Office on Aug. 4, 2004 and assigned Serial No. 2004-61529, the entire contents of which are hereby incorporated by reference.

### BACKGROUND OF THE INVENTION

1. Field of the Invention

The present invention relates to a message processing method and apparatus in a portable Internet system. More particularly, the present invention relates to a method and apparatus for increasing the number of mobile subscriber stations that can be processed by a base station in a portable Internet system.

2. Description of the Related Art

Digital cellular portable communication systems have improved channel capability and voice quality compared to analog cellular portable communication systems providing voice and low-speed data services. However, digital cellular portable communication systems are still restricted from providing various multimedia services.

Due to this restriction, International Mobile Telecommunication-2000 (IMT-2000) has been proposed with the aim to provide not only voice services but also multimedia services such as a high-speed data service on Internet and an image service.

At present, however, constructing such a portable communication system is expensive, and thus subscribers have to pay a lot for wireless Internet services. Besides, there still exist obstacles to provide various content since existing terminals have a small-sized display unit. Accordingly, there are limitations to providing high-speed wireless Internet services.

Furthermore, even though wireless Local Area Network (LAN) technologies using existing Industrial Scientific and Medical (ISM) bandwidth can be applied to a home LAN in a small area, there are limitations in providing public services owing to radio wave interference and so on.

In order to overcome such limitations, a high-speed portable Internet system having a wider service cell area than a wireless LAN has been proposed. This system can support middle/low speed mobility as well as seamless services.

The portable Internet system is a system that intermediates between a wireless LAN and a wireless Internet based upon mobile communications to afford advantages of these services.

With such a portable Internet system, a user or subscriber can access the Internet at a maximum transmission rate of 50 Mbps in stationary indoor/outdoor environments or mobile environments such as walking and middle/low speed movement, by using various types of portable terminals such as a notebook computer, a Personal Digital Assistant (PDA) and a Handheld PC, to use various information and contents.

Available services of the portable Internet system may be classified into transmission services such as Internet access, E-mailing and search, amusement services such as photograph transmission, Video on Demand (VoD) and games and business services such as remote approval or payment and electronic commerce.

As wired and wireless networks are integrated, the mobility of personal terminals is improved, and communication technologies develop an increase in data transmission speed and capability enhancement, it is expected that various application services will appear in the future.

Furthermore, since dynamic image-related services, Internet broadcast services and other services requiring massive database access technologies are expected, a next-generation mobile communication system will be able to transmit/receive data at a high speed of up to several hundreds Mbps by using 2 to 60 GHz bandwidth.

FIG. 1 is a block diagram for illustrating a portable Internet system.

Referring to FIG. 1, a number of Mobile Subscriber Station (MSS) 10 are connected to a Base Station (BS) 20, which is connected to an Internet Protocol (IP) network 40 via a gateway 30.

The IP network 40 includes a server 50, which comprises a special purpose server such as an Authentication, Authorization and Accounting (AAA) server, a Home Agent (HA) server, a Dynamic Host Configuration Protocol (DHCP) server.

At initial booting, each of the MSSs 10 accesses the BS 20, requesting registration. When registration is enabled via the BS 20, the MMS 10 transmits a service request message to the IP network 40 via user selection, and provides the user with a service according to a packet transmitted from the IP network 40.

The BS 20 serves to exchange messages with the MMSs 10 located in a corresponding service cell, authenticate and register the MMSs 10 via the server 50 in the IP network 40, and transmit service request messages from the MMSs 10 to the IP network 40 and packets from the IP network to the MMSs 10.

However, such a portable Internet system is restricted in the number of the MMSs 10 that a single BS 20 can handle via wireless connection.

Accordingly, it is necessary to be able to increase the number of the MMSs 10 that the single BS 20 can handle as well as to efficiently manage information necessary for the BS 20 to provide a service to the MMSs 10.

### SUMMARY OF THE INVENTION

The present invention has been made to solve the foregoing problems of the prior art and it is therefore an exemplary object of the present invention to provide a message processing method and apparatus in a portable Internet system which can increase the number of Mobile Subscriber Stations (MSSs) that a single base station can provide a service to via a packet exchange in a portable Internet system while efficiently managing information necessary for a process by which each MSS connects to the portable Internet system via a wireless link to be serviced therefrom.

According to an exemplary aspect of the invention for realizing the foregoing object, A portable Internet system for providing Internet service to plurality of terminals comprising at least one connection-processor for processing an initial ranging procedure or a basic capability procedure for the terminal and providing connection information of the terminal and at least one connection-controller for processing an authentication procedure and a Quality of Service (QoS) negotiation procedure according to connection information of the terminal received from the connection-processor.

According to another exemplary aspect of the invention for realizing the foregoing object, A message processing method in a portable Internet system, which comprises at least one terminal, at least one connection processor and a connection controller internally connected with the connection processor, the method comprising steps of allocating basic Connection Identifier (CID) information and primary management CID information to the terminal upon receiving a connection information request message from the terminal, setting basic capability information of the terminal according to physical layer information and authentication policy information upon receiving a capability request message from the terminal, exchanging authentication-related parameter information with an authentication server to process an authentication procedure upon receiving an authentication request message via the connection processor from the terminal.

According to another exemplary aspect of the invention for realizing the foregoing object, An authentication processing method in a portable Internet system, which comprises at least one terminal, at least one connection processor and a connection controller internally connected with the connection processor, the method comprising steps of transmitting to the connection controller an Hbis-Security Request message that requests authentication-related parameter information of the terminal upon receiving an authentication request message from the terminal, exchanging authentication-related parameter information with an authentication server to process an authentication procedure upon the Hbis-Security Request message from the connection processor, transmitting to the connection processor an Hbis-Security Response message that includes authentication-related parameter information of the terminal, transmitting to the terminal an authentication response message upon the Hbis-Security Response message from the connection controller.

According to another exemplary aspect of the invention for realizing the foregoing object, A method for acquiring subscriber information of a terminal in a portable Internet system, which comprises at least one terminal, at least one connection processor and a connection controller internally connected with the connection processor, the method comprising steps of transmitting to the connection controller an Hbis-Registration Request message for request registration information of the terminal, acquiring subscriber information of the terminal from a subscriber information server to provide registration information upon receiving the Hbis-Registration request message from the connection processor, transmitting an Hbis-Registration Response message containing results about requested registration information.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a portable Internet system;

FIG. 2 is a block diagram illustrating an exemplary portable Internet system according to an exemplary embodiment of the invention;

FIG. 3 is an internal block diagram illustrating an exemplary access point (AP) according to an exemplary embodiment of the invention;

FIG. 4 is a conceptual view illustrating exemplary functions performed by an AP according to an exemplary embodiment of the invention;

FIG. 5 is an internal block diagram illustrating an exemplary APC according to an exemplary embodiment of the invention;

FIG. 6 is a conceptual view for illustrating exemplary functions performed by an APC according to an exemplary embodiment of the invention;

FIG. 7 is a flowchart for illustrating exemplary message flows of a portable Internet system according to an exemplary embodiment of the invention; and

FIGS. 8A, 8B and 8C are exemplary flowcharts illustrating a message processing method in a portable Internet system according to an exemplary embodiment of the invention.

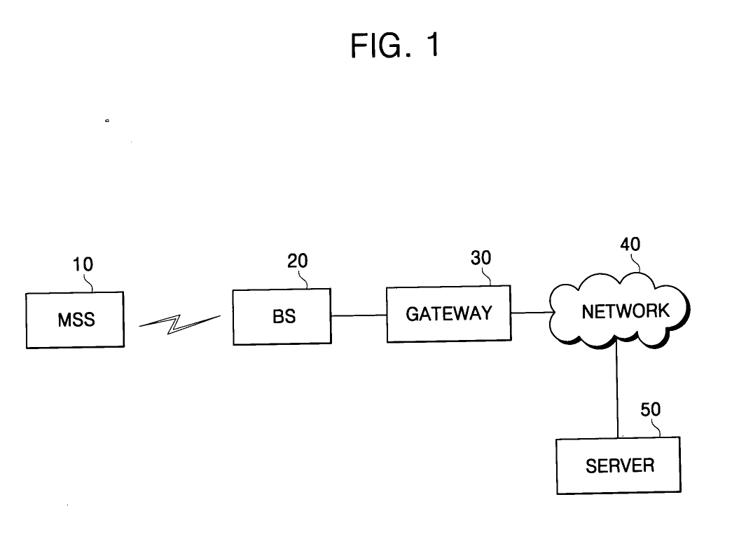

### DETAILED DESCRIPTION OF EXEMPLARY EMBODIMENTS

Exemplary embodiments of the present invention will be described herein below with reference to the accompanying drawings. In the following description, well-known functions or constructions are not described for conciseness.

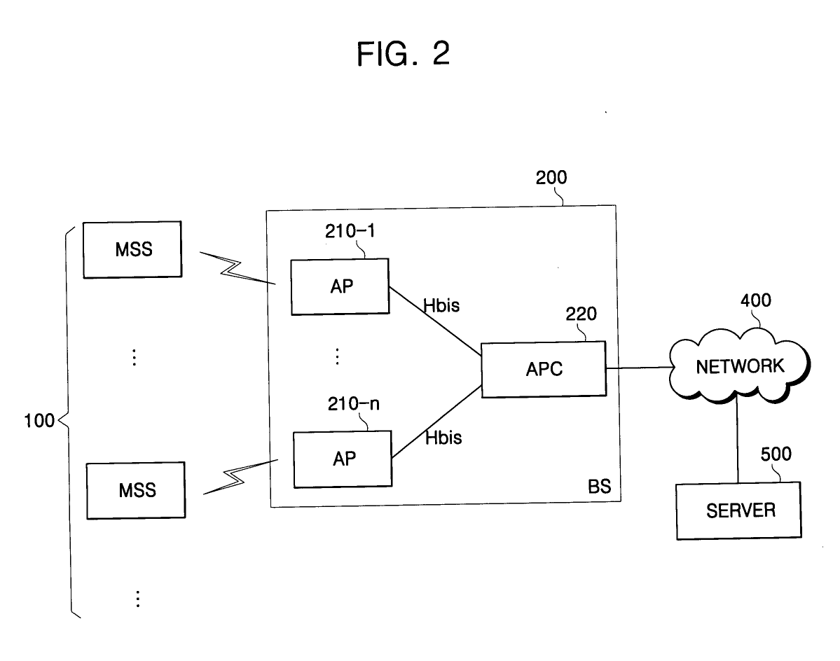

FIG. 2 is a block diagram illustrating an exemplary portable Internet system according to an exemplary embodiment of the invention.

Referring to FIG. 2, the portable Internet system of the invention comprises a number of Mobile Subscriber Stations (MSSs) 100, a Base Station (BS) 200 wirelessly connected to the MSSs 100 and a server 500 connected to the BS 200 via an Internet Protocol (IP) network 400.

The server 500 may comprise at least one of an Authentication, Authorization and Accounting (AAA) server, an HA server, a Dynamic Host Configuration Protocol (DHCP) server and so on.

The AAA server functions to process authentication, authorization and accounting to each MSS 100 connected via the IP network 400.

The HA server processes routing of mobile IP address information and a packet of the MSS 100, which accesses the HA server via the IP network 400, to support the mobility of the MSS 100.

The DHCP server allocates IP addresses to be used in the IP network 400 to each MSS 100 connected via the IP network 400.

The BS 200 comprises a plurality of access points (APs) 210 and an access point controller (APC) 220 connected to the APs 210 via internal interfaces (hereinafter referred to as ‘Hbis interface’).

Each of the MSSs 100 is wirelessly connected to the APC 220 that covers the current location of the MSS 100 as a service cell. The MMS 100 receives a message transmitted from the BS 200 upon initial access, wirelessly scans a corresponding one of the APs 210 to be connected, and acquires parameters for tuning or connecting to down link and up link channels. Examples of the message may comprise a Down Channel Descriptor (DCD) message, a Down Link MAP (DL-MAP) message, an Up Channel Descriptor (UCD) message, an Up Link MAP (UL-MAP) message and so on.

The MMS 100 exchanges packets via the IP network 400 according to subscriber selection.

When the MMS 100 is initially accessed, the BS 200 allocates a basic Connection Identifier (CID) and primary CID information to the MMS 100 and transmits a reply message in response to a request message from the MMS 100.

Each of the APs 210 of the BS 200 forms a Protocol Data Unit (PDU) according to a media access control (MAC) header and a MAC subheader, authenticates the PDU having management CID, and processes coding to the PDU having a transport CID.

The AP 210 allocates and manages a Generic Route Encapsulation (GRE) header tunnel key, processes a message, which is exchanged through an Hbis interface connected to the APC 220, and allocates and manages a connection ID for exchanging a message with the APC 220.

The AP 210 generates a MAC header and a MAC subheader according to information included in a message transmitted from the APC 220, enabling a PDU to be formed, and performs routing for a packet received via a physical layer.

The APC 220 classifies packets, compresses packet headers, and exchanges messages with the APs 210 via an Hbis interface.

That is, the APC 220 generates and transmits a reply message in response to a request message from the APs 210, allocates and manages Service Flow (S/F) ID and GRE tunnel key information, and manages privacy key information transmitted from the server 500 via the IP network 400.

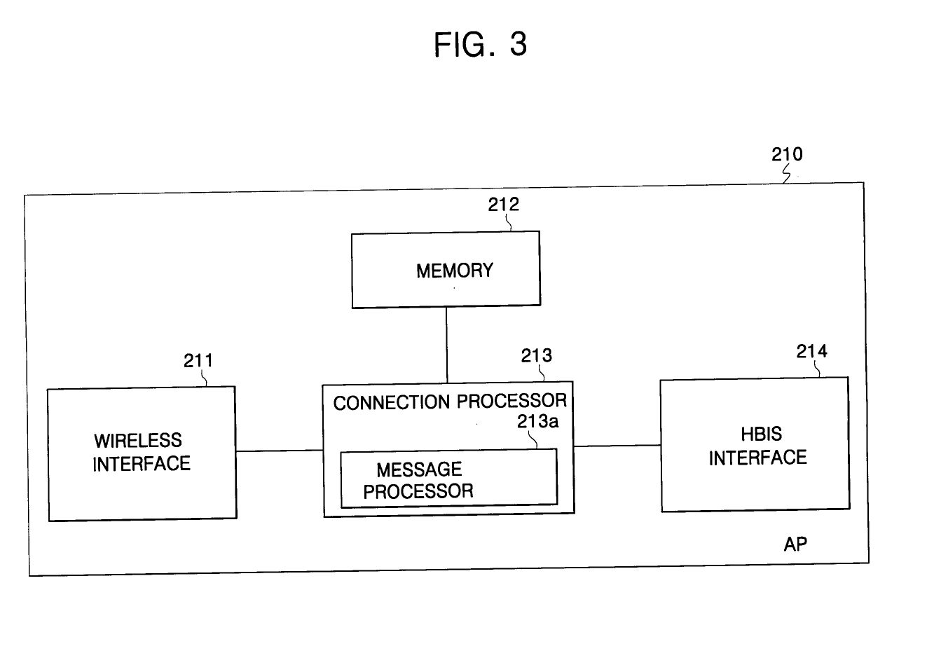

FIG. 3 is an internal block diagram illustrating an exemplary AP according to an exemplary embodiment of the invention.

Referring to FIG. 3, the AP 210 comprises a wireless interface 211, a connection processor 213, a memory 212 and an Hbis interface 214, in which the connection processor 213 comprises a message processor 213a.

The wireless interface 211 receives a request message from the MSS 100 via a wireless link, and transmits a reply message from the AP 210 to the MSS 100.

The memory 212 stores operating program information of the AP 210, parameter information allowing the memory 212 to exchange a message with the MSS 100 via the wireless link, and CIID information allocated to the MSS 100.

The Hbis interface 214 transmits an Hbis message, which is generated by the AP 210, to the APC 220 via the Hbis interface, and receives an Hbis message transmitted from the APC 220.

The connection processor 213 generates a reply message in response to a request message transmitted from the MSS 100, and generates an Hbis message for reporting information allocated to the MSS 100 to the APC 220.

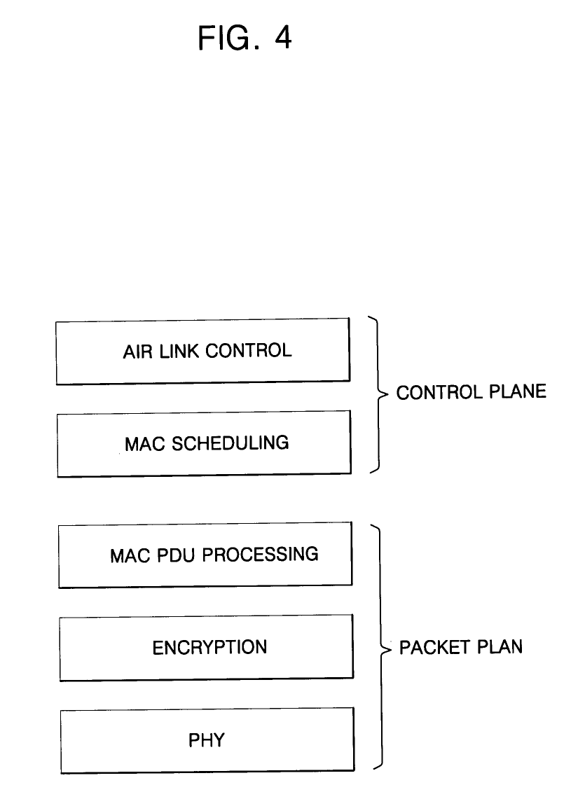

FIG. 4 is a conceptual view illustrating exemplary functions performed by an AP according to an exemplary embodiment of the invention.

Referring to FIG. 4, the functions of the AP 210 according to exemplary embodiment of the invention may be generally grouped into packet and control plan aspects. In the packet plan aspect, the AP 210 performs Physical (PHY), encryption, MAC PDU processing functions. In the packet plan aspect, the AP 210 performs MAC scheduling and wireless control functions.

The encryption function is performed to authenticate a PDU having management CID, encrypt a PDU having transport CID, and maintain Security Association (SA) with the APC 220.

The MAC PDU processing function is performed to constitute a PDU by using a MAC header and a MAC subheader, and comprises fragmentation and packing.

In addition, for the MAC scheduling function, the AP 210 generates a MAC header and a MAC subheader for a down link packet according to the packet scheduling and Hbis interface information connected to the APC 220, and transmits a packet to the IP network 400 according to an up link.

In this case, packet transmission via the up link corresponds to any of Unsolicited Grant Service (UGS), real-time Polling Service (rtPS), non-real-time Polling Service (nrtPS) and Best Effort (BE) scheduling.

As the air link control function, the AP 210 processes a MAC management message, generates an Hbis request message to be exchanged with the APC 220 via the Hbis interface so that the AP 210 can exchange signaling information with the APC 220 by using the Hbis message, and allocates and manages connection ID information and GRE tunnel key information.

That is, the AP 210 authenticates and encodes a received PDU and exchanges registration information, which is necessary for providing a service to the MSS 100, with the APC 220 by using the Hbis message.

The message processor 213a of the connection processor 213 periodically generates and transmits DCD, DL-MAP, UCD and UL-MAP messages to the APC 220 upon initial access of the MSS 100. The message processor 213a also generates and transmits an Hbis request message to the APC 220 in response to a request message received from the MSS 100.

The message processor 213a stores parameter information of an Hbis reply message received from the APC 220 into the memory 212, or generates and transmits a reply message containing parameter information to the MSS 100.

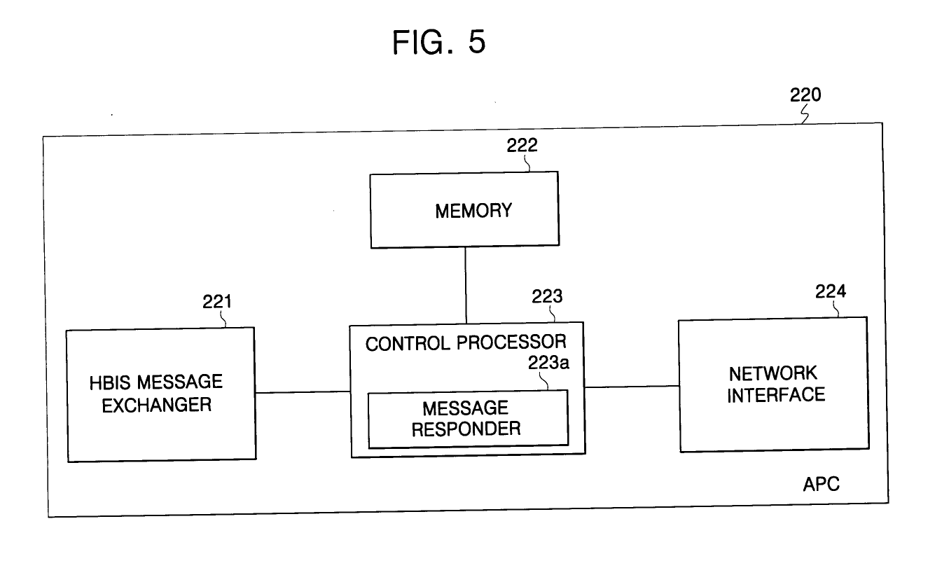

FIG. 5 is an internal block diagram illustrating an exemplary APC according to an exemplary embodiment of the invention.

Referring to FIG. 5, the APC 220 of the invention comprises an Hbis message exchanger 221, a control processor 223, a network interface 224 and a memory 222, in which the control processor 223 comprises a message responder 223a.

The Hbis message exchanger 221 receives an Hbis request message transmitted from the AP 210 via the Hbis interface, and transmits an Hbis reply message generated by the APC 220 to a corresponding one of the APs 210.

The control processor 223 transmits a request message to the server 500, which is connected via the network, in response to an Hbis message received via the Hbis message exchanger 221. The control processor 223 also transmits an Hbis reply message to the AP 210, in which the Hbis reply message is provided according to registration information or authentication information provided by the server 500.

The network interface 224 transmits a request message generated by the control processor 223 to the server 500 via the IP network, and registration and authentication information provided by the server 500 to the control processor 223.

Besides, it is preferable that the network interface 224 has a gateway function so that a request message generated by the control processor 223 can be transmitted to the server 500 via the IP network 400.

In addition, the message responder 223a of the control processor 223 generates a request message in response to an Hbis request message transmitted from the AP 210 to transmit the request message to the server 500, or generates an Hbis reply message containing registration or authentication information provided by the server 500 to transmit the Hbis reply message to the AP 210.

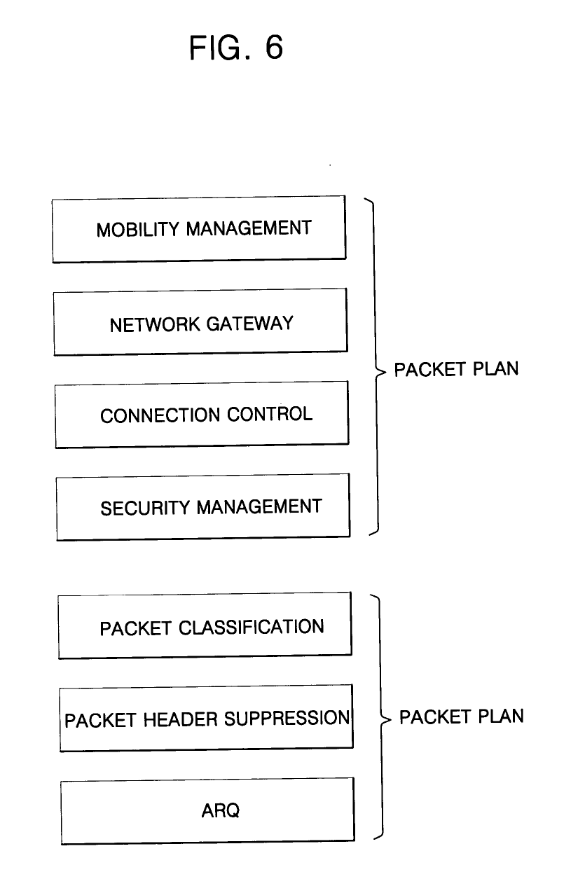

FIG. 6 is a conceptual view illustrating exemplary functions performed by an APC according an exemplary embodiment of the invention.

Referring to FIG. 6, the APC 220 of the invention processes Automatic Repeat Request (ARQ) and Packet Classification function in a packet plan aspect, and Security Management, Connection Control, Network Gateway and Mobility Management functions in a control plan aspect.

The ARQ function is that the APC 220 exchanges a subheader with each of the APs 210 via the Hbis interface in order to process ARQ.

The Packet Header Suppression function compresses a header of a packet; the packet classification function classifies and maps a received packet according to a Service Flow (S/F).

The security management function manages privacy key information provided from the server 500. The Connection Control function exchanges signaling information via the Hbis interface connected to the AP 210 as well as to allocate/manage service flow ID information and GRE tunnel key information.

The Network Gateway function authenticates received packets, and enables the APC 220 to match the server 500 via the network.

The message responder 223a of the control processor 223 stores parameters contained in a Hbis request message received from the AP 210, or generates and transmits a request message to the server 500.

The message responder 223a transmits an Hbis reply message containing authentication-related information or registration information provided from the server 500 to the AP 210.

The Hbis message exchanged between the AP 210 and the APC 220 may have a structure as follows:

Hbis Signaling Message Format

{

Hbis Message Type
Length
AP/APC Job ID
Mandatory field
TLV-encoded Information Element

}

Like this, the Hbis message exchanged between the AP 210 and the APC 220 can be used to exchange parameter information via ‘Mandatory field’ and ‘TLV-encoded Information Element’ areas.

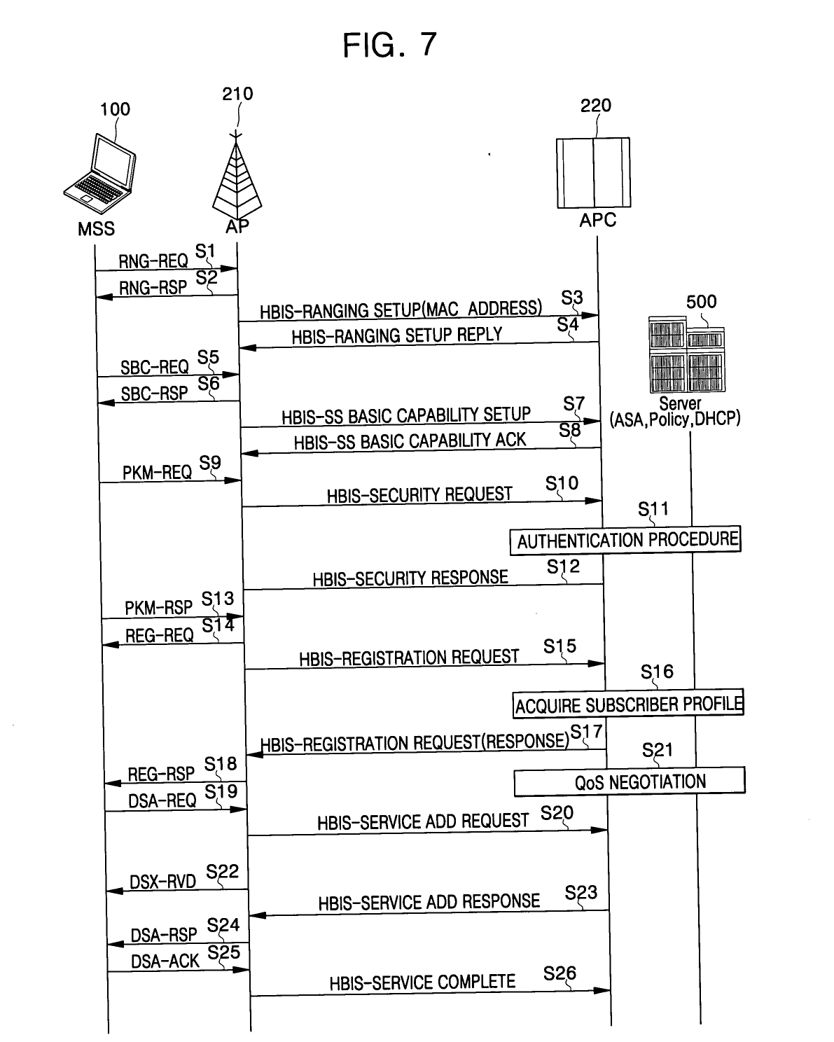

FIG. 7 is a flowchart for illustrating exemplary message flows of a portable Internet system according to an exemplary embodiment of the invention.

Referring to FIG. 7, when initially accessed by the BS 200, the MSS 100 scans a corresponding AP 210 to be connected via a wireless link according to DCD, DL-MAP, UCD, UL-MAP messages that are periodically transmitted from the AP 210.

The MSS 100 acquires Down Link (DL) channel synchronization and Up Link (UL) channel synchronization parameters from the scanned AP 210, synchronizes down and up channels to the AP 210, and then transmits a ranging request (RNG-REQ) message containing a MAC address to the AP 210 in step S1.

The MSS 100 may use an initial Ranging CID to transmit the RNG-REQ message to the AP 210.

The AP 210 allocates Basic CID information and Primary Management CID information to the MSS 100, and upon receiving a RNG-REQ message from the MSS 100, transmits a RNG-RSP message containing allocated Basic CID and Primary Management CID to the MSS 100 in step S2.

Besides, the AP 210 generates an Hbis-Ranging Setup message containing Basic CID information and Primary Management CID information allocated to the MSS 100, and transmits the Hbis-Ranging Setup message to the APC 220 in step S3.

Table 1 below describes parameters contained in the Hbis-Ranging Setup message that is transmitted by the AP 210 when the MSS 100 is initially accessed.

In addition, the definition of the parameters contained in the message described below will not be described in detail since it is specified in IEEE 802.16d, which is hereby incorporated by reference.

TABLE 1

| Name | Description | | |
|---|---|---|---|
| Message Type | | | |
| Length | | | |
| AP)/APC Job ID | | | |
| Basic CID | | | |
| Primary Management CID | | | |
| IE Name | T | L | Value |
| SS MAC Address | | | |
| MAC Version | | | |

As shown in Table 1 above, the AP 210 can transmit Basic CID and Primary Management CID to the APC 220 via the Hbis-Ranging Setup message.

The AP 210 transmits the Hbis-Ranging Setup message to the APC 220 by using set default IP address of the APC 220 and User Data Protocol (UDP) port number.

According to set default IP address information and UDP port number information, the APC 220 provides a signaling path for the exchange of signaling messages to the MSS 100.

In the meantime, in step S4, the APC 220 generates an Hbis-Ranging Setup Reply message containing IP address information and UDP port number information in use for an Hbis message path according to allocated Basic CID information and Primary CID information, and transmits the Hbis-Ranging Setup Reply message to the AP 210.

Table 2 below describes parameters of the Hbis-Ranging Setup Reply message that the APC 200 transmits.

TABLE 2

| Name | Description |
|---|---|
| Message Type | |
| Length | |
| AP(210)/APC(220) Job ID | |
| IP Address | (for Basic and Primary Management CID) |
| Port | (for Basic and Primary Management CID) |

As described in Table 2 above, the APC 220 can transmit IP address information and UDP port information numbers to the AP 210, on the Hbis-Ranging Setup Reply message.

On the other hand, Table 3 describes parameters for a situation that the APC 220 transmits the Hbis-Ranging Setup Reply message containing serving BS-ID.

TABLE 3

| Name | Description | | |
|---|---|---|---|
| Message Type | | | |
| Length | | | |
| AP)/APC Job ID | | | |
| IP Address | (for Basic and Primary Management CID) | | |
| Port | (for Basic and Primary Management CID) | | |
| IE Name | T | L | Value |
| Service Level Prediction | | | |
| Global Service Class Name | | | |
| QoS Parameters Set | | | |
| SFID | | | |
| Resource Retain Flag | | | |

As described in Table 3 above, the APC 220 can transmit the Hbis-Ranging Setup Reply message containing parameter information according to serving BS-information via parameter IE name that can be added in the form of Type Length Value (TLV).

In step S5, the MSS 100 transmits an SS Basic CAP (210) ability Request (SBC-REQ) message containing Physical parameter information of a physical layer, which is supported by the MSS 100, and Authentication policy information to a corresponding AP 210.

The AP 210 sets parameter values common in Physical parameter and Authentication policy information, which is contained in the SBC-REQ message received from the MSS 100, and parameter information of the AP 210 to generate and transmit an SS Basic CAP(210)ability Repose (SBC-RSP) message to the MSS 100 in step S6.

In S7, the AP 210 generates an Hbis-SS Basic cAP(210)ability Setup message containing Basic CAP(210)ability information of the MSS 100, and transmits the Hbis-SS Basic cAP(210)ability Setup message to the APC 220.

Table 4 below describes parameters of the Hbis-SS Basic capability Setup message that the AP 210 transmits.

TABLE 4

| Name | Description | | |
|---|---|---|---|
| Message Type | | | |
| Length | | | |
| AP/APC Job ID | | | |
| IE Name | T | L | Value |

| | | |
|---|---|---|
| Physical | Subscriber transition gaps | |
| Parameter | Maximum transmit power | |
| Supported | Current transmit power | |
| | OFDMA SS FFT sizes | |
| | OFDMA SS demodulator | 64-QAM, BTC, CTC, |
| | | AAS, H-ARQ |
| | OFDMA SS modulator | |
| | The number of H-ARQ | |
| | ACK channel | |
| | OFDMA SS Permutation | PUSC, FUSC, AMC |
| | support | |

Authorization Policy Support

As described in Table 4 above, the AP 210 can transmit the Basic CAP(210)ability of a corresponding MSS 100 to the APC 220, on the Hbis-SS Basic cAP(210)ability Setup message.

In step S8, the APC 220 stores Basic Capability information contained in the received Hbis-PSS Basic Capability Setup message in the memory 222, generates an Hbis-PSS Basic Capability Setup Ack message therefrom, and transmits the Hbis-PSS Basic Capability Setup Ack message to the AP 210.

Table 5 below describes parameters of the Hbis-PSS Basic Capability Setup Ack that the PAC 220 transmits.

TABLE 5

| Name | Description |
|---|---|
| Message Type | |
| Length | |
| AP/APC Job ID | |

As described in Table 5, the APC 220 can indicate that it has received Basic Capability information contained in the Hbis-PSS Basic Capability Setup message via the Hbis-PSS Basic Capability Setup Ack message.

In step S9, the MSS 100 generates and transmits a Privacy Key Management Request (PKM-REQ) message to the AP 210, for the purpose of connection authentication.

In this case, the PKM-REQ message transmitted by the MSS 100 can have a message type selected from the group consisting of Authorization Request, Key Request, EAP(210) Transfer Request and so on.

The AP 210, upon receiving the PKM-REQ message from the MSS 100, generates and transmits an Hbis-Security Request message that requests authentication-related parameter information of the MSS 100 to the APC 220 in step S10.

Table 6 describes parameters of the Hbis-Security Request message that the AP 210 transmits.

TABLE 6

| Name | Description | | |
|---|---|---|---|
| Message Type | | | |
| Length | | | |
| AP/APC Job ID | | | |
| IE Name | T | L | Value |
| Code | | | |
| PKM Identifier | | | |
| Attributes | | | |

As described in Table 6 above, the AP 210 can request parameter information of the MSS 100 related with authentication to the APC 220 via the Hbis-Security Request message.

In this case, the Hbis-Security Request message may comprise one selected from the group consisting of an Authentication Request message, a Key Request message and an EAP Transfer Request message.

Table 6a below describes parameters of the Authentication Request message.

TABLE 6a

| | | | |
|---|---|---|---|
| IE Name | T | L | Value |

| SS-Certificate | | X.509 User Certificate |
|---|---|---|
| Security- | CryptogrAP(210)hic | Allowed cryptographic suites |
| Capability | Suite List | Data encryption algorithm |
| | | identifier (e.g., CBC-Mode) |
| | | Data authentication algorithm |
| | | identifierTEK encryption |
| | | algorithm identifier |
| | | (e.g., RSA) |
| | Version | Version of PKM, security |

| | |
|---|---|
| SAID | Primary SAID (Basic CID) |

Table 6b below describes parameters of the Key Request message.

TABLE 6b

| IE Name | T | L | Value |
|---|---|---|---|
| EAP Payload | | | Described in RFC2284bis |

In addition, Table 6c below describes parameters of the EAP Transfer Request message.

TABLE 6c

| Information Element | Values | Type |
|---|---|---|
| EAP Payload | Described in RFC2284bis | M |

The APC 220, upon receiving the Hbis-Security Request message, exchanges authentication-related parameter information with the server 500 according to an EAP policy in order to process subscriber authentication of the MSS 100 in step S11.

In this case, the server 500 may comprise an ASA server 500.

In step S12, the APC 220 stores authentication-related parameter information exchanged with the ASA server 500, and then generates and transmits an Hbis-Security Response to the AP 210 in step S12.

In this case, the Hbis-Security Response message may comprise one selected from the group consisting of an Authentication Response message, a Key Response message and an EAP Transfer Response message.

Table 7 below describes parameters of the Hbis-Security Response message that the APC 220 transmits.

TABLE 7

| IE Name | T | L | Value |
|---|---|---|---|
| Code | | | |
| PKM Identifier | | | |
| Attributes | | | |

As described in Table 7a below, the APC 220 can transmit authentication-related parameter information via the Hbis-Security Response message.

TABLE 7a

| IE Name | | T | L | Value |
|---|---|---|---|---|
| AUTH-Key | | | | 128-byte quantity |
| | | | | representing as RSA- |
| | | | | encrypted AK |
| Key-Lifetime | | | | |
| Key-Sequence-Number | | | | |
| SA- | SAID | | | |
| Descriptor | | | | |
| | SA-Type | | | Primary SAID (Basic CID) |
| | CryptogrAP(210)hic- | | | |
| | Suite | | | |

Table 7b below describes parameters of the Key Response message.

TABLE 7b

| IE Name | | T | L | Value |
|---|---|---|---|---|
| Key-Sequence-Number | | | | |
| SAID | | | | |
| TEK | TEK | | | Encrypted with the KEK |
| Parameters | Key-Lifetime | | | TEK Remaining Lifetime |
| | Key-Sequence- | | | TEK Sequence Number |
| | Number | | | |
| | CBC-IV | | | CBC Initialization Vector |

Table 7c below describes parameters of the EAP Transfer Response message.

TABLE 7c

| IE Name | T | L | Value |
|---|---|---|---|
| EAP Payload | | | Described in RFC2284bis |

After storing authentication-related parameters contained in the received Hbis-Security Response message, the AP 210 generates and transmits a Privacy Key Management Response (PKM-RSP) message according to message type to the MSS 100 in step S13.

The MSS 100, upon completion of authentication, transmits a Registration Request (REG-REQ) message to the AP 210 in step S14. The REG-REQ message contains service and Convergence Sublayer (CS) related Capability information, ARG parameters and registration information such as whether to support a Management mode.

When the REG-REQ message is received, the AP 210 transmits allocates Secondary Management CID to the MSS 100, and generates and transmits an Hbis-Registration Request message requesting registration information to the APC 220 in step S15.

Table 8 below describes parameters of the Hbis-Registration Request message that the AP 210 transmits.

TABLE 8

| Name | | Description | | |
|---|---|---|---|---|
| Message Type | | | | |
| Length | | | | |
| AP/APC Job ID | | | | |
| Secondary Management CID | | | | |
| GRE Tunnel Key | | (for Secondary Management CID) | | |
| IP Address | | | | |
| IE Name | | T | L | Value |
| Uplink CID Support | | | | The number of Uplink CIDs the PSS can |
| | | | | support |
| SS Management Support | | | | Whether or not the PSS is managed |
| IP Management Mode | | | | |
| IP Version | | | | |
| SS | ARQ support | | | |
| Capabilities | DSx flow control | | | |
| Encoding | MAC CRC support | | | |
| | MCA flow control | | | |
| | Multicast polling group CID | | | |
| | support | | | |
| | PKM flow control | | | |
| | Authorization policy support | | | |
| | Maximum number of | | | |
| | supported SAs | | | |
| Vendor ID Encoding | | | | |
| Vendor-specific Information | | | | |
| CS | CS (Convergence Sublayer) | | | |
| CAP(210) | support | | | |
| abilities | Maximum number of | | | |
| | classifiers | | | |
| | PHS support | | | |
| ARQ | ARQ Enable | | | |
| Parameters | ARQ_WINDOW_SIZE | | | |
| | ARQ_RETRY_TIMEOUT | | | The sum of Transmitter Delay and |
| | | | | Receiver Delay |
| | ARQ_BLOCK_LIFETIME | | | |
| | ARQ_SYNC_LOSS | | | |
| | ARQ_DELIVER_IN_ORDER | | | |
| | ARQ_PURGE_TIMEOUT | | | |
| | ARQ_BLOCK_SIZE | | | |

| | |
|---|---|
| Method for allocating IP address | DHCP, Mobile Ipv4, DHCPv6, Ipv6 |
| | Stateless Address Auto-configuration |
| Mobility features supported | Mobility(Handoff), Sleep-mode, Idle- |
| | mode support |
| Sleep-mode recovery time | |

As described in Table 8 above, the AP 210 can request registration information of the MSS 100 from the APC 220 via the Hbis-Registration Request message.

The APC 220, upon receiving the Hbis-Registration Request message, acquires subscriber information or profile about the MSS 100 from the server 500 in step S16.

In step S17, the APC 220 replies with an Hbis-Registration Response message containing results about requested registration information, GRE Tunnel Key information about Secondary Management CID and IP address information.

Table 9 below describes parameters of the Hbis-Registration Response message that the APC 220 transmits.

| Name | | Description | | |
|---|---|---|---|---|
| Message Type | | | | |
| Length | | | | |
| AP/APC Job ID | | | | |
| GRE Tunnel Key | | (for Secondary Management CID) | | |
| IP Address | | AP(210)/APC(220) IP address (for | | |
| | | Secondary Management CID) | | |
| IE Name | | T | L | Value |
| Response | | | | |
| SS Management Support | | | | Whether or not the PSS is managed |
| IP Management Mode | | | | |
| IP Version | | | | |
| SS | ARQ support | | | |
| Capabilities | DSx flow control | | | |
| Encoding | MAC CRC support | | | |
| | MCA flow control | | | |
| | Multicast polling group CID | | | |
| | support | | | |
| | PKM flow control | | | |
| | Authorization policy support | | | |
| | Maximum number of | | | |
| | supported SAs | | | |
| Vendor ID Encoding (of the responder) | | | | |
| Vendor-specific Information | | | | |
| CS | CS (Convergence Sublayer) | | | |
| CAP(210) | support | | | |
| abilities | Maximum number of | | | |
| | classifiers | | | |
| | PHS support | | | |
| ARQ | ARQ Enable | | | |
| Parameters | ARQ_WINDOW_SIZE | | | |
| | ARQ_RETRY_TIMEOUT | | | The sum of Transmitter Delay and |
| | | | | Receiver Delay |
| | ARQ_BLOCK_LIFETIME | | | |
| | ARQ_SYNC_LOSS | | | |
| | ARQ_DELIVER_IN_ORDER | | | |
| | ARQ_PURGE_TIMEOUT | | | |
| | ARQ_BLOCK_SIZE | | | |

Method for allocating IP address
Mobility features supported

As described in Table 9 above, the APC 220 can transmit registration information to the MSS 100 via the Hbis-Registration Response message.

In step S18, the AP 210 generates and transmits a Registration Response (REG-RSP) message to the MSS 100, in which the REG-RSP message contains results about registration information contained in the Hbis-Registration Response message and Secondary Management CID.

Where the MSS 100 supports a Subscriber Station (SS) and IP Management mode, the MSS 100 can additionally acquire IP address information and parameter information necessary for management and execute management in an IP Management policy.

In order to acquire IP address necessary for the exchange of packets for the MSS 100 to provide a service, a Dynamic Host Configuration Protocol (DHCP) process is performed.

That is, in step S19, the MSS 100 transmits a Dynamic Service Addition Request (DSA-REQ) message containing Service Flow (SF) information and CS parameter information to the AP 210.

The AP 210, upon receiving the DSA-REQ message, allocates Transport CID to the MSS 100, and transmits an Hbis-Service Add Request message to the APC 220 in step S20. The Hbis-Service Add Request message contains IP address information and GRE Tunnel Key information for packet-tunneling with the APC 220.

Table 10 below describes the Hbis-Service Add Request message that the AP 210 transmits.

| Name | | Description | | |
|---|---|---|---|---|
| Message Type | | | | |
| Length | | | | |
| AP(210)/APC(220) Job ID | | | | |
| Transaction ID | | | | |
| GRE Tunnel Key | | (for Secondary Management CID) | | |
| IP Address | | AP(210)/APC(220) IP address (for Tunnel) | | |
| IE Name | | T | L | Value |
| Service | Service Flow Identifier (SFID) | | | |
| Flow | Transport CID | | | |
| Parameters | Service Class name | | | |
| | QoS Parameter Set Type | | | Provisioned Set, Admitted Set, Active |
| | | | | Set |
| | Traffic Priority | | | |
| | Maximum Sustained Traffic Rate | | | |
| | Maximum Traffic Burst | | | |
| | Minimum Reserved Traffic Rate | | | |
| | Minimum Tolerable Traffic Rate | | | |
| | Service Flow Scheduling Type | | | |
| | Request/Transmission Policy | | | |
| | Tolerated Jitter | | | |
| | Maximum Latency | | | |
| | Fixed-length versus Variable- | | | Used only if packing is on for the |
| | length SDU Indicator | | | service flow |
| | SDU Size | | | |
| | Target SAID | | | |
| | ARQ TLVs for ARQ-enabled | | | |
| | connection | | | |
| CS | CS Specification | | | IPv4, IPv4 over 802.3, ATM, etc |
| Parameter | Classifier rule priority | | | The priority for the Classifier |
| Encodings | IP TOS/DSCP range and mask | | | |
| | Protocol | | | Protocal field in IP header |
| | IP masked source address | | | IP addresses and their corresponding |
| | | | | address masks |
| | IP destination address | | | |
| | Protocol source port range | | | |
| | Protocol destination port range | | | |
| | Ethernet destination MAC address | | | |
| | Ethernet source MAC address | | | |
| | Ethertype/IEEE802.2-1998 | | | |
| | SAP(210) | | | |
| | IEEE 802.1D-1998 User_Priority | | | |
| | IEEE 802.1A-1998 VLAN_ID | | | |
| | Associated PHSI | | | |
| | Packet Classifier Rule Index | | | |
| | Vendor-specific classifier | | | |
| | parameters | | | |
| | PHS DSC action | | | |
| | PHS errror parameter set | | | |
| | PHS Rule | | | PHSI, PHSF, PHSM, PHSS, PHSV |
| | IPv6 Flow label | | | |

As described in Table 10 above, by using the Hbis-Service Add Request message, the AP 210 can request CS parameter information and service flow parameter information in use for a service to the MSS 100.

The APC 220, upon receiving the Hbis-Service Add Request message, negotiates with the Policy server 500 based upon QoS policy information about the subscriber in step S21.

In step S22, the AP 210 generates and transmits a DSx Received Message (DSx-RVD) message in order to notify the MSS 100 that a DSA process is progressing.

The APC 220 generates and transmits an Hbis-Service Add Response message to the AP 210 in step S23. The Hbis-Service Add Response message contains Confirmation Code, requested SF-CS parameter result value and GRE Tunnel Key and IP address in use for packet tunneling with the AP 210.

Table 11 below describes the Hbis-Service Add Response message that the APC 220 transmits.

| Name | | Description | | |
|---|---|---|---|---|
| Message Type | | | | |
| Length | | | | |
| AP/APC Job ID | | | | |
| Transaction ID | | | | |
| GRE Tunnel Key | | Traffic Tunnel Key between AP(210) and | | |
| | | APC(220) | | |
| IP Address | | (AP/APC) IP address (for Tunnel) | | |
| IE Name | | T | L | Value |
| Service | Service Flow Identifier (SFID) | | | |
| Flow | Service Class name | | | |
| Parameters | QoS Parameter Set Type | | | Provisioned Set, Admitted Set, Active |
| | | | | Set |
| | Traffic Priority | | | |
| | Maximum Sustained Traffic Rate | | | |
| | Maximum Traffic Burst | | | |
| | Minimum Reserved Traffic Rate | | | |
| | Minimum Tolerable Traffic Rate | | | |
| | Service Flow Scheduling Type | | | |
| | Request/Transmission Policy | | | |
| | Tolerated Jitter | | | |
| | Maximum Latency | | | |
| | Fixed-length versus Variable- | | | |
| | length SDU Indicator | | | |
| | ARQ TLVs for ARQ-enabled | | | |
| | connection | | | |
| | CS Specification | | | IPv4, IPv4 over 802.3, ATM, etc |
| | Classifier rule priority | | | The priority for the Classifier |
| | IP TOS/DSCP range and mask | | | |
| CS | Protocol | | | Protocol field in IP header |
| Parameter | IP masked source address | | | IP addresses and their corresponding |
| Encodings | | | | address masks |
| | IP destination address | | | |
| | Protocol source port range | | | |
| | Protocol destination port range | | | |
| | Ethernet destination MAC address | | | |
| | Ethernet source MAC address | | | |
| | Ethertype/IEEE802.2-1998 SAP | | | |
| | IEEE 802.1D-1998 User_Priority | | | |
| | IEEE 802.1A-1998 VLAN_ID | | | |
| | Associated PHSI | | | |
| | Packet Classifier Rule Index | | | |
| | Vendor-specific classifier | | | |
| | parameters | | | |
| | PHS DSC action | | | |
| | PHS error parameter set | | | |
| | PHS Rule | | | PHSI, PHSF, PHSM, PHSS, PHSV |
| | IPv6 Flow label | | | |

As described in Table 11 above, the APC 220 can transmit Confirmation Code information, Service Flow (SF) information and CS parameter information via the Hbis-Service Add Response message.

In step S24, the AP 210 transmits Confirmation Code, SF information and CS parameter result value contained in the Hbis-Service Add Response message via a Dynamic Service Addition Response (DSA-RSP) message.

The MSS 100, upon successfully receiving the DSA-RSP message, generates and transmits a Dynamic Service Addition Acknowledge (DSA-ACK) message to the AP 210 in step S25.

The AP 210, upon receiving the DSA-RSP message from the MSS 100, generates and transmits an Hbis-Service Complete message to the APC 220 in order to notify whether or not a call for providing a service is established in step S26.

Table 12 below describes parameters of the Hbis-Service Complete message that the AP 210 transmits.

TABLE 12

| | |
|---|---|
| Name | Description |

Message Type
Length
AP/APC Job ID
Transaction ID
Result (ACK/NACK)

As described in Table 12 above, the AP can indicate whether or not a call is established via the Hbis-Service Complete message.

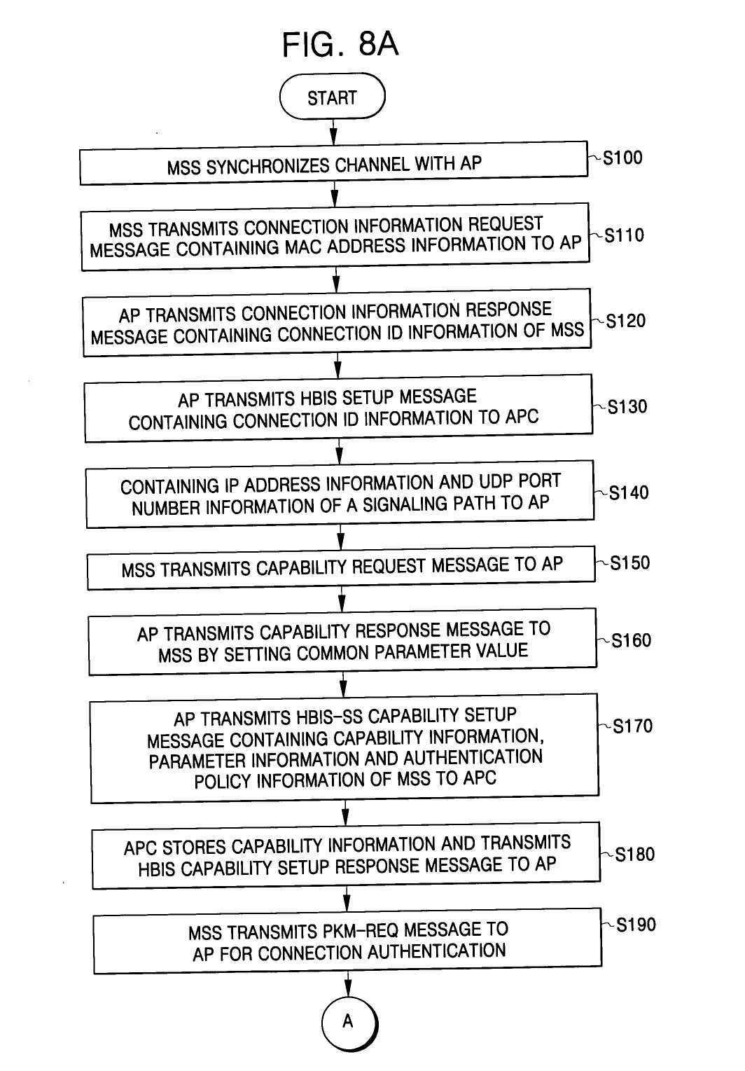

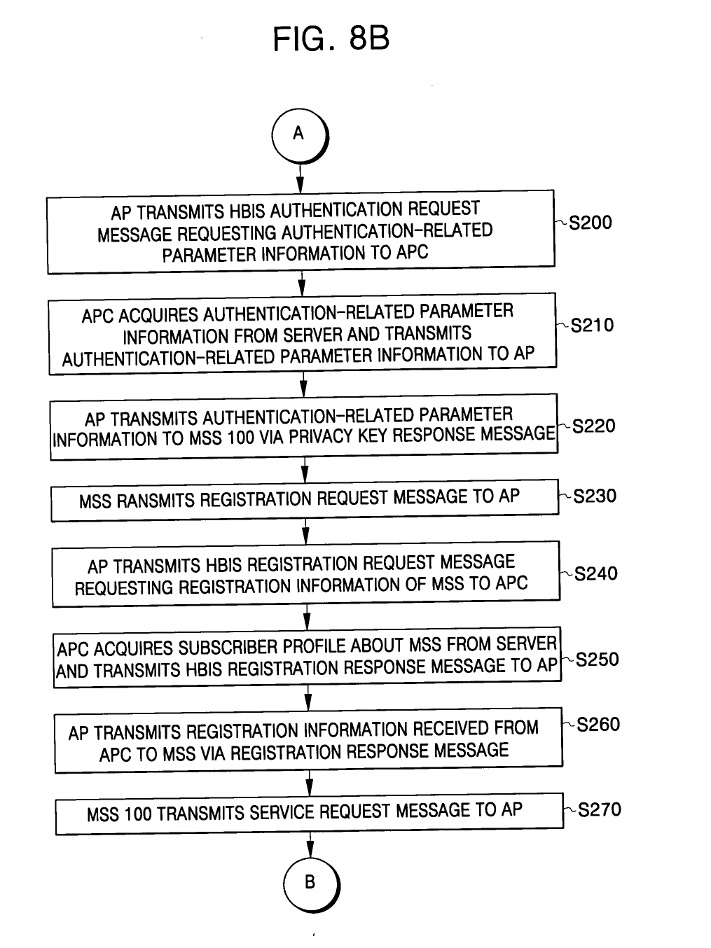

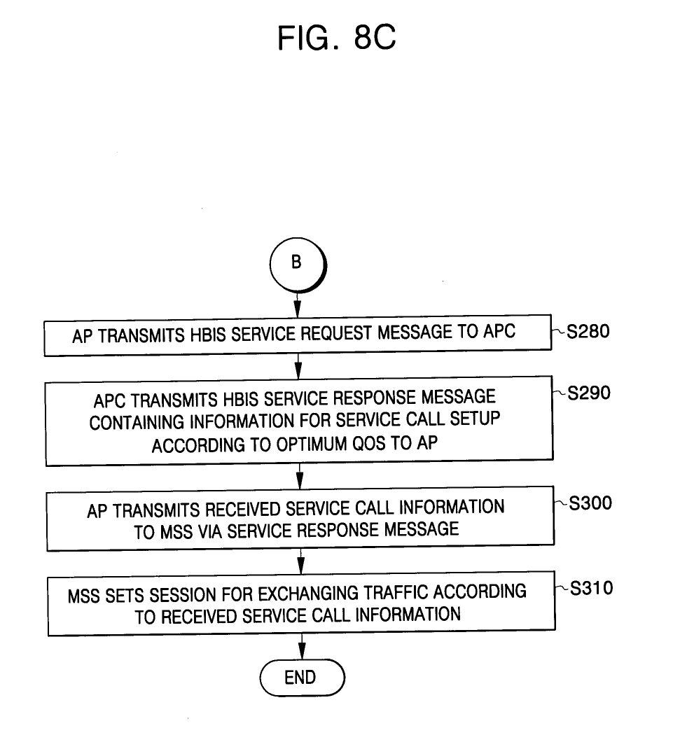

FIGS. 8A, 8B and 8C are exemplary flowcharts for illustrating a message processing method in a portable Internet system according to an exemplary embodiment of the invention.

Referring to FIGS. 8A, 8B and 8C, at initial booting, each of the MSSs 100, according to DCD, DL-MAP(210), UCD, UL-MAP(210) messages which are periodically transmitted from the AP 210, scans a corresponding one of the APs 210 to connect via a wireless link, acquires DL channel synchronization and UL channel synchronization parameters, and synchronizes the AP 210 and down and up channels in step S100.

The MSS 100 transmits a connection request message containing an allocated MAC address to the AP 210 via initial Ranging CID in step S110.

In S120, the AP 210 allocates connection ID information to the MSS 100 to connect, and upon receiving the connection request message from the MSS 100, transmits a connection information response message containing connection ID information to the MSS 100.

Examples of connection ID information may comprise Basic CID information and Primary Management CID information.

In step S130, the AP 210 transmits an Hbis setup message containing connection ID information allocated to the MSS 100 toward the APC 220.

The AP 210 transmits the Hbis setup message to the APC 220 by using default IP address information and UDP port number of the set APC 220.

In step S140, the APC 220 transmits an Hbis setup response message to the AP 210, containing IP address information and UDP port number information of a signaling path, through which signaling messages about the MSS 100 are exchanged, according to connection ID information contained in the receiving Hbis setup message.

In step S150, the MSS 100 transmits a Capability request message containing physical layer parameter information and authentication policy information to the AP 210.

The AP 210 transmits a capability response message to the MSS 100 by setting common parameter values according to physical layer parameter information and authentication policy information contained in the received capability request message in step S160.

In step S170, the AP 210 generates and transmits an Hbis-SS capability setup message containing capability information, parameter information and authentication policy information of the MSS 100 to the APC 220.

The APC 220 stores capability information contained in the received Hbis-PSS capability setup message, and generates and transmits an Hbis capability setup response message to the AP 210 in step S180.

Upon the completion of setting parameter information and authentication policy information for connection with the BS 200 via a wireless link, the MSS 100 transmits a Privacy Key Management Request (PKM-REQ) message to the AP 210 for the purpose of connection authentication in step S190.

The PKM-REQ message transmitted from the MSS 100 may comprise one selected from the group consisting of Authentication Request, Key Request and EAP(210) Transfer Request.

The AP 210, upon receiving the PKM-REQ message from the MSS 100, generates and transmits an Hbis authentication request message to the APC 220, requesting authentication-related parameter information of the MSS 100 in step S200.

The APC 220, upon receiving the Hbis authentication request message from the AP 210, acquires authentication-related parameter information from the server 500 to process subscriber authentication for the MSS 100, and transmits authentication-related parameter information to the AP 210 via the Hbis authentication response message in step S210.

In step S220, the AP 210 transmits authentication-related parameter information contained in the received Hbis authentication message to the MSS 100 via a privacy key response message.

The MSS 100 upon receiving the privacy key response message, generates a registration request message by using registration information containing service and CS related CAP(210)ability information, ARQ parameter information and mode support information, and transmits the registration request message to the AP 210 in step S230.

The AP 210, upon receiving the registration request message, allocates connection ID information at the time of the registration of the MSS 100, and transmits an Hbis registration request message to the APC 220, requesting registration information of the MSS 100 in step S240.

In step S250, upon receiving the Hbis registration request message, the APC 220 acquires subscriber profile about the MSS 100 from the server 500, and transmits an Hbis registration response message containing IP address information and GRE Tunnel Key information according to connection ID information and registration result information necessary for the registration of the MSS 100 to the AP 210.

The AP 210 transmits registration information contained in the Hbis registration response message received from the APC 220 to the MSS 100 via the registration response message in step S260.

In step S270, the MSS 100, upon the completion of registration via the BS 200, transmits a service request message to the AP 210, requesting SF parameter information and CS parameter information in order to acquire IP address information necessary for setting a call for packet exchange.

The AP 210, upon receiving the service request message, allocates Transport CID to the MSS 100, and then transmits an Hbis service request message to the APC 220 in step S280. The Hbis service request message contains SF parameter information, CS parameter information and GRE Tunnel Key and IP address information necessary for packet tunneling with the APC 220.

The APC 220, upon receiving the Hbis service request message, performs negotiations for setting a service call of optimum QoS according to a QoS policy, and transmits an Hbis service response message containing Confirmation Code information, SF parameter information, CS parameter result value and GRE Tunnel Key and IP address information in use for packet tunneling with the AP 210 in step S290.

In step S300, the AP 210 transmits Confirmation Code information contained in the received Hbis service response message, SF information and CS parameter result value to the MSS 100 via the service response message.

When the MSS 100 successfully receives the service response message, the MSS 100 transmits a confirmation message to the AP 210. Then, the AP 210, upon receiving the confirmation message from the MSS 100, notifies the APC 220 whether or not call-setting is succeeded.

In step S310, the MSS 100 transmits a packet generated according to subscriber selection to the IP network 400 via a session that is set according to Confirmation Code information, SF information and CS parameter result value.

While the present invention has been shown and described in connection with the exemplary embodiments, it will be apparent to those skilled in the art that modifications and variations can be made without departing from the spirit and scope of the invention as defined by the appended claims.

As described hereinbefore, the exemplary embodiments of the present invention make it possible to increase the number of MSSs that a single base station can provide a service to via packet exchange in a portable Internet system and to efficiently manage information necessary for a process by which each MSS connects to the portable Internet system via a wireless link to be serviced therefrom.

What is claimed is:

1. A portable Internet system for providing Internet service to plurality of terminals comprising:
at least one connection-processor for processing an initial ranging procedure or a basic capability procedure for the terminal and providing connection information of the terminal; and
at least one connection-controller for processing an authentication procedure and a Quality of Service (QoS) negotiation procedure according to connection information of the terminal received from the connection-processor.

2. The portable Internet system according to claim 1, wherein the connection-processor is adapted to transmit at least one selected from a group consisting of basic Connection Identifier (CID) information, Primary Management CID information and basic capability information according to the initial ranging procedure or the basic capability procedure.

3. The portable Internet system according to claim 1, wherein the connection-processor is adapted to, upon receiving a connection information request message containing MAC address information from the terminal, allocate basic CID information and Primary Management CID information to the terminal, and upon receiving a capability request message containing physical layer information and authentication policy information, set basic capability information of the terminal.

4. The portable Internet system according to claim 1, wherein the connection controller is adapted to, upon receiving an authentication request message via the connection-processor, exchange authentication-related parameter information with an authentication server to perform an authentication procedure, and upon receiving a registration request message via the connection-processor, acquire subscriber information of the terminal from a subscriber information server to provide registration information.

5. The portable Internet system according to claim 4, wherein the registration information comprises at least one selected from a group consisting of secondary management CID information, key information and IP address information.

6. The portable Internet system according to claim 1, wherein the connection-controller comprises:
a wireless interface for setting a wireless link with the terminal;
a connection processor for processing the initial ranging procedure or the basic capability procedure according to the request message received via the interface or generating and transmitting an internal request message containing the connection information to the connection-controller; and
an internal interface for transmitting the internal request message to the connection-controller and receiving an internal response message from the connection-controller.

7. The portable Internet system according to claim 1, wherein connection-controller comprises:
a message exchanger for receiving an internal request message from the connection-processor and transmitting an internal response message to the connection-processor; and
a controlling processor for processing the authentication procedure and the QoS procedure by acquiring parameter information from a server connected via a network according to the internal request message received via the message exchanger, and generating the internal response message containing registration information according to the procedures.

8. The portable Internet system according to claim 1, wherein the connection-controller comprises:
a physical layer;
an encryption layer for processing PDU authentication and encoding;
a media access control (MAC) Protocol Data Unit (PDU) processing layer for forming a PDU by using a MAC header and a MAC subheader;
a MAC scheduling layer for scheduling packets; and
a wireless link-controlling layer for allocating key information and connection ID information, transmitting connection information to the connection controller, and receiving registration information from the connection-controller.

9. The portable Internet system according to claim 1, wherein the connection-controller comprises:
an Automatic Repeat Request (ARQ) block layer for exchanging a subheader with the connection-controller to process ARQ;
a packet header suppression layer for compressing a packet header;
a Packet Classification layer for classifying packets and mapping the packets according to a service flow;
a security management layer for managing privacy key information;
a connection control layer for allocating tunnel key information and service flow ID information and receiving connection information from the connection processor;
a network gateway layer for authenticating packets, allowing packet reception from a network; and
a mobility management layer for supporting the mobility of the terminal.

10. A message processing method in a portable Internet system, which comprises at least one terminal, at least one connection processor and a connection controller internally connected with the connection processor, the method comprising steps of:
allocating basic Connection Identifier (CID) information and primary management CID information to the terminal upon receiving a connection information request message from the terminal;
setting basic capability information of the terminal according to physical layer information and authentication policy information upon receiving a capability request message from the terminal;
exchanging authentication-related parameter information with an authentication server to process an authentication procedure upon receiving an authentication request message via the connection processor from the terminal.

11. The message processing method according to claim 10, further comprising: acquiring subscriber information of the terminal from a subscriber information server to provide registration information upon receiving a registration request message via the connection processor from the terminal.

12. The message processing method according to claim 10, further comprising:
upon receiving a service request message from the terminal, transmitting service flow information, Convergence sublayer (CF) information, key information and IP information of the terminal to the connection controller upon receiving a service request message from the terminal; and
negotiating service quality with a policy server.

13. The message processing method according to claim 10, further comprising:
transmitting basic CID information, primary management CID information and basic capability information of the terminal to the connection controller; and
transmitting registration information to the connection processor.

14. The message processing method according to claim 13, wherein the registration information comprises at least one selected from a group consisting of secondary management CID information, key information and IP address information.

15. The message processing method according to claim 12, wherein the step of negotiating further comprises:
negotiating service quality using service flow information, Convergence sublayer (CF) information, key information and IP information of the terminal.

16. An authentication processing method in a portable Internet system, which comprises at least one terminal, at least one connection processor and a connection controller internally connected with the connection processor, the method comprising steps of:
transmitting to the connection controller an Hbis-Security Request message that requests authentication-related parameter information of the terminal upon receiving an authentication request message from the terminal; and
exchanging authentication-related parameter information with an authentication server to process an authentication procedure upon the Hbis-Security Request message from the connection processor; and
transmitting to the connection processor an Hbis-Security Response message that includes authentication-related parameter information of the terminal; and
transmitting to the terminal an authentication response message upon the Hbis-Security Response message from the connection controller.

17. A method for acquiring subscriber information of a terminal in a portable Internet system, which comprises at least one terminal, at least one connection processor and a connection controller internally connected with the connection processor, the method comprising steps of:
transmitting to the connection controller an Hbis-Registration Request message for request registration information of the terminal; and
acquiring subscriber information of the terminal from a subscriber information server to provide registration information upon receiving the Hbis-Registration request message from the connection processor; and
transmitting an Hbis-Registration Response message containing results about requested registration information.
